(19) United States
(12) Patent Application Publication
(10) Pub. No.: US 2025/0193507 A1
(43) Pub. Date: Jun. 12, 2025

(54) USER SENSING DYNAMIC CAMERA RESOLUTION CONTROL

(71) Applicant: Microsoft Technology Licensing, LLC, Redmond, WA (US)

(72) Inventors: Eli BAREL, Rosh-HaAyin (IL); Shoham DEKEL, Tel Aviv (IL)

(21) Appl. No.: 18/536,924

(22) Filed: Dec. 12, 2023

(51) Int. Cl. H04N 23/611; G06V 40/10; H04N 23/65; H04N 23/667; H04N 23/80

(52) U.S. Cl. CPC H04N 23/611; H04N 23/651; H04N 23/667; H04N 23/80; G06V 40/10

(57) ABSTRACT

User sensing dynamic camera resolution control is implemented by adapting camera settings and/or image processing based on sensed conditions, such as detected changes in an environment indicating user presence while approaching or retreating from a computing device. Dynamic adaptation of camera settings and/or image processing can conserve power and/or reduce user wait time by preparing to resume operation and greet a user as the user arrives at a computing device. An image processor uses sensed conditions to increment and decrement camera power consumption and/or image processing power consumption by dynamically switching between modes, such as powering and/or processing a single subpixel, multiple subpixels, a single pixel, multiple pixels, multiple pixels in a heatmap mode, low, medium, and high/full resolution, at one or fields of view, based on a series of events detected using the camera sensor alone or combined with other sensors, such as a sound sensor (e.g., microphone).

### BACKGROUND

Computing devices that continue running while not in use consume unnecessary power. Such draining of power particularly affects portable devices that rely on batteries. Such draining of power can also pose security risks. Accordingly, users may put devices to sleep to conserve power and/or maintain device security. Startup from sleep may be a multi-step process to power-up the device, authenticate, and restore the display to make it ready for use.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods are disclosed herein for user sensing dynamic camera resolution control. Dynamic adaptation of camera settings and/or image processing are based on sensed conditions, such as detected changes in an environment indicating actual or potential user presence, including a detection of the user approaching or retreating from a computing device. Dynamic adaptation of camera settings and/or image processing can conserve power and/or reduce user wait time by preparing to resume operation and greet a user as the user arrives at a computing device. An image processor uses sensed conditions to increment and decrement camera power consumption and/or image processing power consumption by dynamically switching between multiple stages, such as powering and/or processing a single subpixel, multiple subpixels, a single pixel, multiple pixels, multiple pixels in a heatmap mode, low, medium, and high/full resolution, at one or fields of view, based on a series of events detected using the camera sensor alone or combined with other sensors, such as a sound sensor (e.g., microphone).

In one aspect, a computing device includes a camera comprising an array of pixels and subpixels configured to generate image data and an image processor configured to reduce power consumption of the computing device by performing image processing of the image data to determine human presence in proximity to the computing device. The image processor increases the image processing incrementally (e.g., in stages) in response to a determination that a human may be advancing towards the computing device (e.g., in an inactive/low power state). The image processor decreases the image processing incrementally in response to a determination that the human retreated from the computing device (e.g., in an active state). The ability to change camera resolution and/or processing resolution (e.g., per application or scenario) enables improvements to computing device security, performance (e.g., reduced processing), and power consumption, e.g., by reducing user image resolution when it is not needed.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system configured to provide user sensing dynamic camera resolution control, in accordance with an embodiment.

FIG. 2 shows a block diagram of an image processor interacting with data storage, the image processor configured to provide user sensing dynamic camera resolution control, in accordance with an embodiment.

FIG. 3 shows a decreasing image processing flow by a computing device implementing user sensing dynamic camera resolution control, in accordance with an embodiment.

FIG. 4 shows an increasing image processing flow by a computing device implementing user sensing dynamic camera resolution control, in accordance with an embodiment.

FIGS. 5A-5C show flowcharts of processes for user-sensing dynamic camera resolution control, according to an embodiment.

FIG. 6 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Computing devices that continue running while not in use consume unnecessary power, which drains batteries in portable devices, and may pose security risks. Users may put devices to sleep to conserve power and/or maintain device security. Startup from sleep is a multi-step process to power-up the device, authenticate, and restore the display to make it ready for use.

Computing devices may include a user presence sensor to maintain the device in an active state, wake up the device (such as in response to detecting a user approaching), or lock the device (such as in response to detecting the user leaving the device) to conserve power and preserve device security. The presence sensor may implement a variety of different types of sensor technologies, such as a camera, time of flight (ToF), ultra wideband (UWB), radio frequency (RF) radar, sonar, etc. When a camera is implemented, the camera may support a variety of features, such as human presence detection to user biometric detection. However, a camera may consume significant power itself and for an image processing algorithm used to resolve images.

As such, systems and methods are disclosed herein for user sensing dynamic camera resolution control that enables power conservation even when a camera is used for controlling a device state. The dynamic adaptation of camera settings and/or image processing are based on sensed conditions, such as detected changes in an environment indicating actual or potential user presence approaching or retreating from a computing device. The dynamic adaptation of camera settings and/or image processing enables the conservation of device power and/or a reduction in user wait time by causing the computing device to prepare to resume operation and greet a user as the user arrives at a computing device. In an embodiment, a image processor uses sensed conditions to increment and decrement camera power consumption and/or image processing power consumption by dynamically switching between multiple stages, such as powering and/or processing a single subpixel, then multiple subpixels, then a single pixel, then multiple pixels, then multiple pixels in a heatmap mode, low, medium, and high/full resolution, at one or more fields of view, etc., based on a series of events detected using the camera sensor alone or combined with other sensors, such as a sound sensor (e.g., microphone).

In examples, a computing device includes a camera comprising an array of pixels and subpixels configured to generate image data and an image processor configured to reduce power consumption of the computing device by performing image processing of the image data to determine human presence in proximity to the computing device. The image processor increases the image processing incrementally (e.g., in stages) in response to a determination that a human may be advancing towards the computing device (e.g., in an inactive/low power state). The image processor decreases the image processing incrementally in response to a determination that the human retreated from the computing device (e.g., in an active state).

Embodiments have numerous advantages. For instance, adaptation of camera settings and/or image processing can conserve power by decreasing device operation when a user leaves the computing device and/or may reduce user wait time by preparing to resume operation and greet a user as the user arrives at a computing device. The ability to change camera resolution and/or processing resolution (e.g., per application or scenario) enables improvements to computing device security, performance (e.g., reduced processing), and power consumption, e.g., by reducing user image resolution when it is not needed.

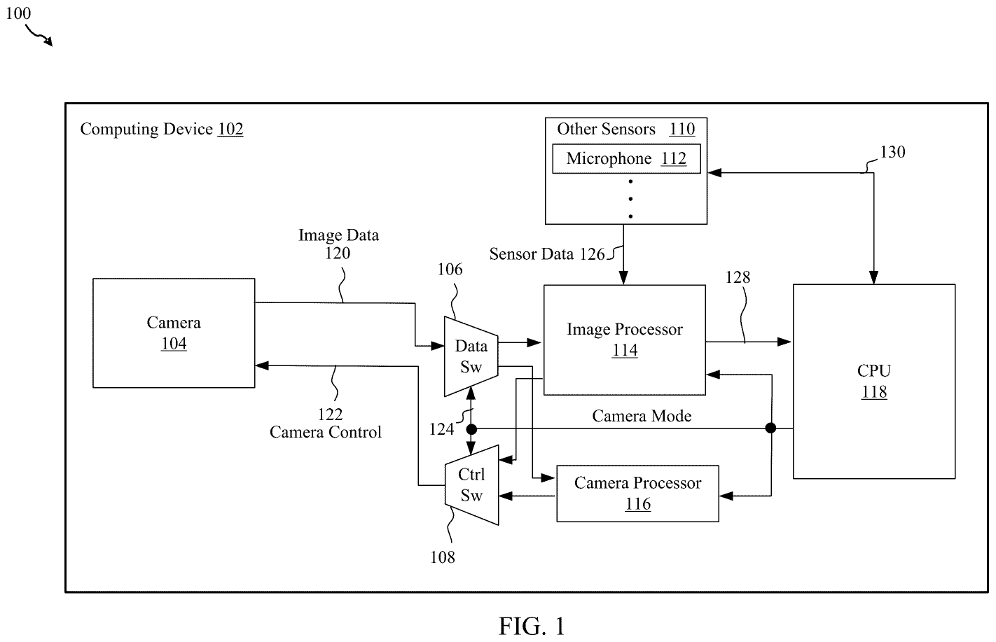

These and further embodiments may be configured in various ways. For instance, FIG. 1 shows a block diagram of a system 100 configured to provide user sensing dynamic camera resolution control, in accordance with an embodiment. As shown in FIG. 1, system 100 includes a computing device 102, which includes a camera 104, a data switch (Sw) 106, control switch 108, one or more other sensors 110, an image processor 114, a camera processor 116, and a CPU 118. These components of computer 102 are described in further detail as follows.

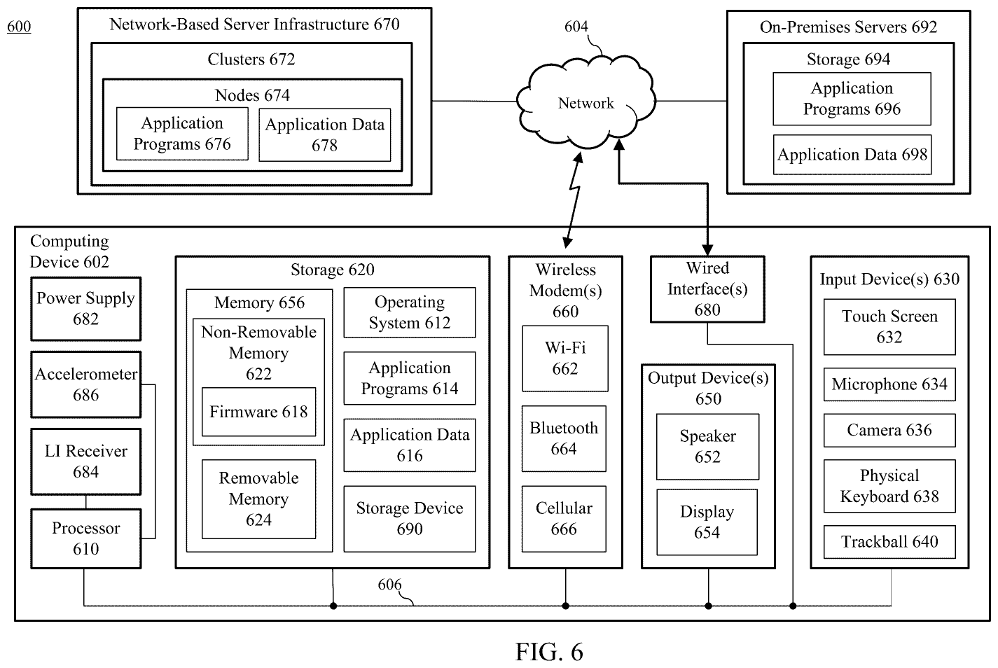

Computing device 102 may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server. An example computing device with example features is presented in FIG. 6. Computing device 102 may comprise a computing device utilized by one or more users (e.g., individual users, family users, enterprise users, governmental users, administrators, etc.). Computing device 102 may comprise one or more applications, operating systems, virtual machines (VMs), storage devices, etc., that may be executed, hosted, and/or stored therein or via one or more other computing devices via network(s) (not shown).

Camera 104 may include any type of camera sensor for capturing images, including single images and/or video. For example, camera 104 may be a fixed camera or a controllable camera. Camera 104 comprises an array of pixels and subpixels. Pixels and subpixels in camera 104 generate image data 120. Camera 104, if controllable, may be controlled by camera control (e.g., a signal) 122. Camera control 122 includes one or more power and/or control signals. In some examples, camera 104 may be controlled by camera control 122 to power or activate selected subpixels, pixels, subsets of pixels, etc. In some examples, the power provided to camera 104 (e.g., by a battery) may be variable, e.g., based on active subpixels and pixels. In some examples, selectable active pixels or subpixels of camera 104 generate image data 120. Camera 104 may have one or more modes. For example, camera may be ON or OFF. In an OFF state/mode, image data 120 may not be provided to camera processor 116 or CPU 118. In an OFF state/mode, image data 120 may be provided to image processor 114. In an ON state/mode, image data 120 may be provided to camera processor 116 or CPU 118.

Data switch 106 receives image data 120 from camera 104. Data switch 106 is controlled by camera mode 124 generated by CPU 118. Data switch 106 is controlled, for example, by camera mode 124 to provide image data to image processor 114 or to camera processor 116. For example, when camera 104 is ON, data switch 106 may provide image data 120 to camera processor 116, and when camera 104 is OFF, data switch 106 may provide image data 120 to image processor 114.

Control switch 108 receives control signals 120 from image processor 114 and camera processor 116. Control switch 108 is controlled by camera mode 124 generated by CPU 118. Control switch 108 is controlled by camera mode 124 to provide control signals from image processor 114 or camera processor 116 to camera 104. For example, when camera 104 is ON, control switch 108 may provide control signals from camera processor 116 as camera control 122 to camera 104, and when camera 104 is OFF, control switch 108 may provide control signals from image processor 114 as camera control 122 to camera 104.

In some examples, image processor 114 controls an operating mode of camera 104, e.g., via camera control 122 when camera mode is OFF. For example, camera control 122 may dynamically increment and decrement power provided to camera 104 and/or indicate active subpixels and pixels in camera 104 to vary resolution, field of view (FOV), etc.

Sensors 110 may include a module or hub coupled to one or more sensors, e.g., other than camera 104. For example, sensors 110 may include microphone 112. Sensors 110 may receive operating system (OS) indications 130 from CPU 118, such as control signals for operational modes (e.g., ON/OFF). Sensors 110 may provide sensor data to CPU 118 (e.g., via sensor data/OS indications 130) and to image processor 114 (e.g., via sensor data 126). Although not shown, similar to data and control switches 106, 108 for camera 104, one or more sensors in sensors 110 may be selectively controlled by and/or may selectively provide data to image processor 114, for example, when CPU 118 is inactive (e.g., in sleep mode).

Camera processor 116 may process image data 120, for example, when CPU 118 indicates camera mode is ON. Camera processor 116 may control camera 104, for example, when CPU 118 indicates camera mode is ON. Camera processor 116 may process images, including a stream of images (e.g., video), such as during video calls through applications operated by CPU 118, e.g., Microsoft Teams® or Zoom®. Camera processor 116 may comprise or may be a component of a graphics card or a graphics processing unit (GPU).

CPU 118 may comprise any type of processor, microcontroller, a microprocessor, signal processor (e.g., digital signal processor (DSP)), application specific integrated circuit (ASIC), and/or other physical hardware processor circuit) for performing computing tasks, such as program execution, signal coding, data processing, input/output processing, power control, and/or other functions. CPU 118 is configured to execute program code, such as an operating system and/or application programs. CPU 118 may perform operations, e.g., based on execution of executable code, which may include one or more steps in processes/methods disclosed herein. CPU 118 may be associated with (e.g., may read and write to) a variety of memory and storage, such as SSD, RAM, ROM, flash memory, MEM, etc.

CPU 118 may execute an operating system (OS), which may generate indications (e.g., control signals), such as OS indications 130 provided to sensors 110. CPU 118 may receive user presence indications 128 from image processor 114. CPU 118 (e.g., via executed program instructions) may use user presence indications 128 to determine camera mode 124 and/or CPU operating mode (e.g., sleep, active). For example, CPU 118 may transition from an active mode to a sleep mode after receiving user presence indications 128 indicating the user is absent over a threshold period of time, which may be set by the user. CPU 118 may transition from a sleep mode to an active mode, for example, in response to user presence indication 128 indicating that the user is present, e.g., detected in the area, facing the computing device 102, near enough to communicate with computing device 102 (e.g., via gestures detectable by camera 104), presses a key or otherwise interacts with an input device, such as a keyboard, touchpad, touchscreen, etc. Transitions of CPU 118 may be set by the user, for example, in user preferences for the operation of computing device 102.

Image processor 114 may be configured to operate at low power. For instance, lower power processor 114 may be an ultra-lower voltage microprocessor that is underclocked (i.e., timing settings are modified to run at a lower clock rate than specified for the processor) so as to consume less power. Image processor 114 may comprise any type of processor, microcontroller, a microprocessor, signal processor (e.g., DSP), ASIC, and/or other physical hardware processor circuit) for performing computing tasks, such as program execution, signal coding, data processing, input/output processing, power control, and/or other functions. Image processor 114 is configured to execute program code, such as an operating system and/or application programs. Image processor 114 may perform operations, e.g., based on execution of executable code, which may include one or more steps in processes/methods disclosed herein. Image processor 114 may be associated with (e.g., may read and write to) a variety of memory and storage, such as SSD, RAM, ROM, flash memory, MEM, etc.

Image processor 114 is configured to (e.g., selectively) control the operation of camera 104 and/or image processing of image data 120 to detect user presence and provide user presence indications 128 to CPU 118 while reducing power consumption by camera 104 and/or image processing based on scenarios indicated by camera 104 alone or in combination with sensors 110, such as microphone 112. For example, image processor 114 may monitor image data 120 generated by camera 104 when camera mode 124 is OFF (e.g., while CPU 118 is in sleep mode). Image processor 114 may generate camera control 122 when camera mode 124 is OFF. Camera control 122 generated by image processor 114 may include power control, subpixel and/or pixel activation/deactivation, e.g., to control resolution and/or FOV.

Image processor 114 may dynamically adapt camera settings for camera 104 and/or image processing of image data 120 based on sensed conditions, such as detected changes in an environment around computing device 102 indicating actual or potential user presence approaching or retreating from a computing device. Dynamic adaptation of camera settings and/or image processing can conserve power and/or reduce user wait time by preparing to resume operation of computing device 102 and greet a user as the user arrives at computing device 102. Image processor 114 uses sensed conditions to increment and decrement camera power consumption by camera 104 and/or image processing power consumption of image processor 114 by dynamically switching between multiple stages, such as powering and/or processing a single subpixel, multiple subpixels, a single pixel, multiple pixels, multiple pixels in a heatmap mode, low, medium, and high/full resolution, at one or fields of view, based on a series of events detected using the camera sensor 104 alone or combined with other sensors, such as a sound sensor (e.g., microphone 112).

Image processor 114 may be a low power image processor configured for image processing (e.g., may employ parallel processing to increase speed and efficiency), and is configured to reduce power consumption of the computing device 102, for example, by: performing image processing of the image data 120 to determine human presence in proximity to the computing device 102; increasing the image processing incrementally (e.g., in stages) in response to a determination that a human may be advancing towards the computing device 102 (e.g., in an inactive/low power state of CPU 118); and decreasing the image processing incrementally in response to a determination that the human retreated from the computing device 102 (e.g., in an active state of CPU 118).

A determination that the human may be advancing towards the computing device 102 may include a series of indications in the image data 120, such as two or more of the following: detecting a color change in at least one subpixel in the array of subpixels; detecting a color change in at least one pixel in the array of pixels; detecting a color change in the camera in a heat map mode; detecting a human form (e.g., or object) in the heat map mode; or detecting a human form at one or more camera resolutions.

The image processor in image processor 114 is configured to indicate the determined human presence to the CPU 118 as user presence indications 128, which CPU 118 may use to make operating mode determinations. For example, image processor 114 may indicate to CPU 118 to activate at the end of a series of incremental increases in image processing and/or to turn off at the beginning of a series of incremental decreases in image processing.

In some examples, image processor 114 may decrease power provided to the camera 104 in association with decreasing the image processing of image data 120. Image processor 114 may increase power provided to the camera 104 in association with increasing the image processing of image data 120.

In some examples, image processor 114 may decrease a field of view of the camera 104 in association with decreasing the image processing of image data 120. Image processor 114 may increase a field of view of the camera 104 in association with increasing the image processing of image data 120.

In some examples, image processor 114 may deactivate a number of pixels or subpixels in the camera in association with decreasing the image processing of image data 120. In some examples, image processor 114 activates a number of pixels or subpixels in the camera in association with increasing the image processing.

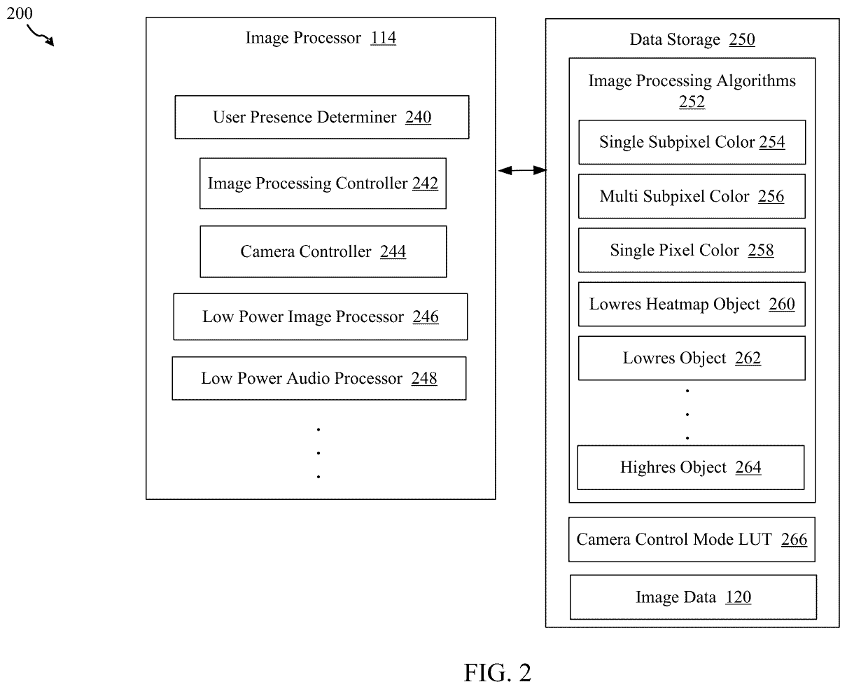

FIG. 2 shows a block diagram of image processor 114 coupled to a data storage 250 and configured to provide user sensing dynamic camera resolution control, in accordance with an embodiment. As shown in FIG. 2, image processor 114 comprises a user presence determiner 240, an image processing controller 242, a camera controller 244, a low power image processor 246, and a low power audio processor 248, e.g., among other sensor data processors. Image processor 114 stores and retrieves executable logic and/or data in data storage 250.

Low power image processor 246 processes image data 120 generated by camera 104, for example, when camera mode 124 is OFF. Low power image processor 246 may apply an image processing algorithm to determine, for example, if there is a change in color or any object detected in previous and current images. Low power image processor 246 may provide the determination to user presence determiner 240, image processing controller 242, and camera controller 244.

Low power audio processor 248 processes audio data in sensor data 126 generated by microphone 112, for example, when camera mode 124 is OFF. Low power audio processor 248 may determine whether audio data indicates sounds consistent with user presence or absence. Low power audio processor 248 may provide the determination to user presence determiner 240, image processing controller 242, and camera controller 244.

User presence determiner 240 determines user presence indications 128 provided to CPU 118, for example, based on the output of low power image processor 242 alone or combined with the output of other sensor processors, such as low power audio processor 248. User presence determiner 240 may determine a user is present (e.g., returning from absence) based on a series of indications of color changes and/or object detections by low power image processor 246, e.g., potentially accompanied by noises consistent with human presence detected by low power audio processor 248. User presence determiner 240 may determine a user is absent based on a series of indications without color changes and/or object detections by low power image processor 246, e.g., potentially accompanied by a lack of noises consistent with human presence detected by low power audio processor 248.

Image processing controller 242 determines an image processing mode to process image data 120, for example, based on the output of low power image processor 242 alone or combined with the output of other sensor processors, such as low power audio processor 248. Image processing controller 242 determines whether to maintain, increment or decrement image processing of image data 120. Image processing controller 242 determines which image processing algorithm should be executed by low power image processor 246. Image processing controller 242 uses determinations by low power image processor 242 (e.g., color changes, object detections, or lack thereof) alone or combined with determinations by low power audio processor 248 (e.g., noises associated with human presence or absence) to maintain or change image processing algorithms, such as single subpixel color change detector 254, multi-subpixel color change detector 256, single pixel color change detector 258, low resolution (lowres) heatmap object detector 260, lowres object detector 262, and so on, to high resolution (highres) object detector 264, or other image processing algorithms.

Camera controller 244 determines a camera operating mode for camera 104, for example, based on the output of low power image processor 242, the output of other sensor processors, such as low power audio processor 248, and/or based on the output of image processing controller 242. Camera controller 244 determines whether to maintain, increment or decrement the resolution, field of view, power, etc. for camera 104. Camera controller 244 determines which subpixels and pixels should be active and what power should be provided consistent with the image processing algorithm selected by image processing controller 242. Camera controller 244 is configured to use determinations by low power image processor 242 (e.g., color changes, object detections, or lack thereof) alone or combined with determinations by low power audio processor 248 (e.g., noises associated with human presence or absence) to determine whether to maintain or change the resolution, field of view, power, etc. for camera 104. Camera controller 244 may select camera configurations using a look up table (LUT), such as camera control mode LUT 266, which may provide selectable combinations of power and control settings for camera 104. The selectable combinations of power and control settings may allow incremental changes in the operation of camera 104.

Data storage 250 stores, for example, one or more image processing algorithms 252, camera control mode look up table (LUT) 266, image data 120, and/or other data, such as determinations by presence determiner 240, image processing controller 242, camera controller 244, low power image processor 246, and/or low power audio processor 248. Data storage 250 may receive read and/or write requests, for example, from user presence determiner 240, image processing controller 242, camera controller 244, low power image processor 246, and low power audio processor 248.

Image processing algorithms 252 include, for example, single subpixel color change detector 254, multi-subpixel color change detector 256, single pixel color change detector 258, low resolution (lowres) heatmap object detector 260, lowres object detector 262, and so on, to high resolution (highres) object detector 264. Image processing algorithms may be selected by image processing controller 242 and executed by low power image processor 246.

Single subpixel color change detector 254 is configured to detect a color change between past and present image data 120 for a single subpixel. For example, past and present subpixel color values for a red, green, or blue subpixel may be between zero and 255. A color change may be detected, for example, if the difference exceeds a threshold difference.

Multi-subpixel color change detector 256 is configured to detect a color change between past and present image data 120 for multiple subpixels. For example, past and present subpixel color values for red, green, and/or blue subpixels may be between zero and 255. Color changes may be detected, for example, if the difference in a threshold number of pixels exceeds a threshold difference.

Single pixel color change detector 258 is configured to detect a color change between past and present image data 120 for a single pixel. For example, past and present subpixel color values for red, green, and blue subpixels for the single pixel may be between zero and 255. A color change may be detected, for example, if the difference in color change exceeds a threshold difference.

Low resolution (lowres) heatmap object detector 260 is configured to detect an object in a heatmap indicated by image data 120 for a set of pixels, such as a 4×8 or 9×16 subset of pixels in the array of pixels comprising camera 104. Lowres heatmap object detector 260 may use a pattern recognition model to determine whether there are any objects in image data 120, such as humanoid shapes that move between images (e.g., video frames).

Lowres object detector 262 is configured to detect an object in image data 120 for a set of pixels, such as a 4×8 or 9×16 subset of pixels in the array of pixels comprising camera 104. Lowres object detector 262 may use a pattern recognition model to determine whether there are any objects in image data 120, such as humanoid shapes that move between images (e.g., video frames). Lowres object detector 262, depending on the subset of pixels, may detect user interactions with computing device 102, such as hand gestures.

High resolution (highres) object detector 264 is configured to detect an object in image data 120 for the array of pixels comprising camera 104. Highres object detector 264 may use a pattern recognition model to determine whether there are any objects in image data 120, such as humanoid shapes that move between images (e.g., video frames). Highres object detector 264 may detect user interactions with computing device 102, such as hand gestures.

Image processing algorithms 252 may include any type of algorithm based on any type of camera configurations and image data 120. Some examples may implement camera configurations or image processing algorithms based on resolution and/or field of view. For example, some algorithms may process border pixels in the camera pixel array while some algorithms may process central pixels in the camera pixel array. Image processing controller 242 may be configured to select image data processing algorithms that implement different fields of view with the same or different resolutions. Camera controller 244 may be configured to select camera configurations from camera control mode LUT 266 according to the selected image processing algorithms.

In various examples, decreasing the image processing incrementally may include changing from performing image processing of image data generated by the array of pixels to performing image processing of image data generated by a first subset of pixels in the array of pixels in response to the image processing indicating that the human started to retreat from the computing device.

In various examples, decreasing the image processing incrementally may include changing from performing image processing of image data generated by the first subset of pixels in the array of pixels to performing image processing of image data generated by a second, smaller, subset of pixels in the array of pixels in response to the image processing indicating that the human continued (e.g., based on a second consecutive determination) to retreat from the computing device.

In various examples, decreasing the image processing incrementally may include changing the image processing from performing image processing of the image data generated by the second subset of pixels in the array of pixels to performing heatmap image processing of the second subset of pixels in response to the image processing indicating that there has been no human presence for a period of time.

In various examples, decreasing the image processing incrementally may include changing the image processing from performing image processing of the image data generated by one pixel to performing image processing of the image data generated by one subpixel in response to the image processing indicating that there has been no human presence for a period of time.

In various examples, increasing the image processing incrementally may include changing from performing image processing of image data generated by the first subset of pixels in the array of pixels to performing image processing of image data generated by the array of pixels in response to the image processing indicating that the human is close enough to interact with the computing device.

In various examples, increasing the image processing incrementally may include changing from performing image processing of image data generated by the second subset of pixels in the array of pixels to performing image processing of image data generated by the first subset of pixels in the array of pixels in response to the image processing indicating that the human continued to advance towards the computing device.

In various examples, increasing the image processing incrementally may include changing the image processing from performing the heatmap image processing of the image data generated by the second subset of pixels to performing image processing of the second subset of pixels in response to the image processing indicating that there has been no human presence for a period of time.

In various examples, increasing the image processing incrementally may include changing the image processing from performing image processing of the image data generated by one subpixel to performing image processing of the image data generated by one pixel in response to the image processing indicating that there may be initial human presence after a period of time without an indication of human presence.

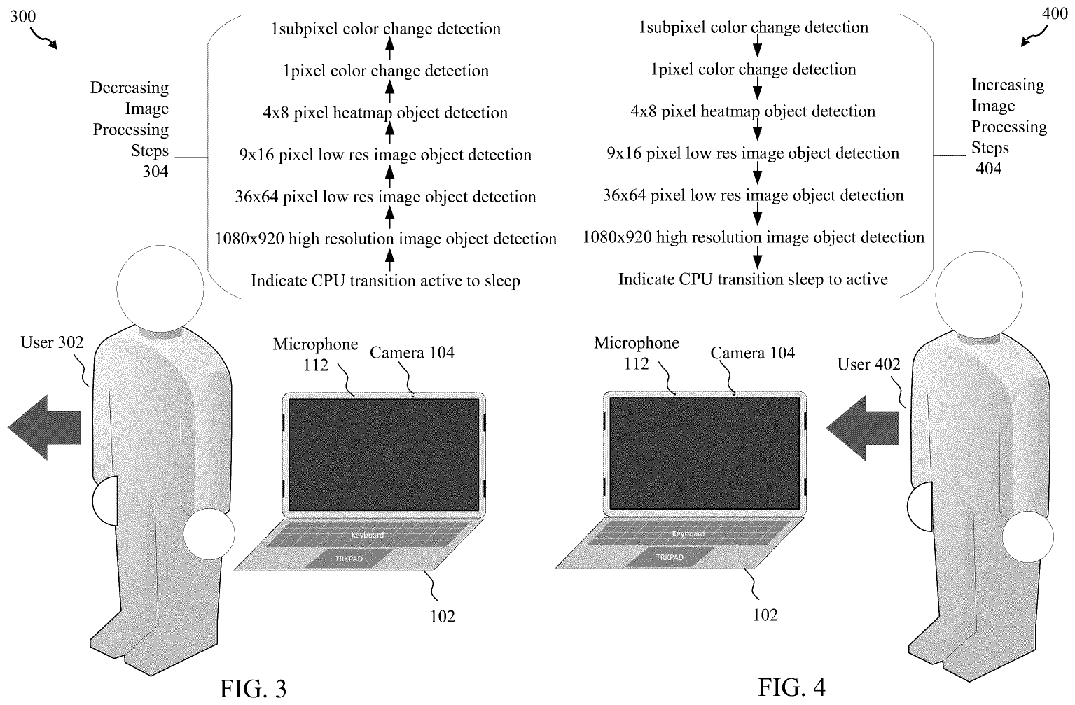

FIG. 3 shows a decreasing image processing flow 300 by a computing device implementing user sensing dynamic camera resolution control, in accordance with an embodiment. Flow 300 shows a user 302 retreating from computing device 102, e.g., configured with camera 104, microphone 112, image processor 114, etc. as described herein. As shown in FIG. 3, computing device 102 implementing user sensing dynamic camera resolution control responds to user absence by decrementing image processing. The example series of decreasing image processing steps 304 may be selected, for example, by image processing controller 242. The example flow of decreasing image processing 304 represents one of many decreasing image processing flows.

In the example, computing device 102 may be in active mode with camera 104 ON. Computing device 102 may enter sleep mode after inactivity and/or after receiving an indication (e.g., from user presence determiner 240) to transition from active to sleep mode following a series of indications of a lack of user presence in image data 120 generated by camera 104 alone or in combination with audio data generated by microphone 112. As image data 120 generated by camera 104 continues to show that user 302 remains absent, image processing controller 242 continues to decrease image processing of image data 120 incrementally by selecting image processing algorithms with reduced processing, such as 1080×920 high resolution image object detection to 36×64 pixel low res image object detection to 9×16 pixel low res image object detection to 4×8 pixel heatmap object detection to 1 pixel color change detection to 1 subpixel color change detection. Camera controller 244 may control camera 104 consistent with selected image processing algorithms, or vice versa. In various implementations, algorithm selection may jump over (skip) multiple algorithms (e.g., and associated camera control configurations), pause at the same algorithm, and so on, for example, based on the detected scenario.

FIG. 4 shows an increasing image processing flow 400 by a computing device implementing user sensing dynamic camera resolution control, in accordance with an embodiment. Flow 400 shows a user 402 advancing towards computing device 102, e.g., configured with camera 104, microphone 112, image processor 114, etc. as described herein. As shown in FIG. 4, computing device 102 implementing user sensing dynamic camera resolution control responds to indications of change in image data (e.g., which, at least initially, may or may not indicate user presence) by incrementing image processing. The example series of increasing image processing steps 404 may be selected, for example, by image processing controller 242. The example flow of increasing image processing steps 404 represents one of many increasing image processing flows.

In the example, computing device 102 may be in sleep mode with camera 104 OFF. As image data 120 generated by camera 104 begins to show changes (e.g., a threshold number of changes), image processing controller 242 begins to increase image processing of image data 120 incrementally by selecting image processing algorithms with increased processing, such as 1 subpixel color change detection to 1 pixel color change detection to 4×8 pixel heatmap object detection to 9×16 pixel low res image object detection to 36×64 pixel low res image object detection to 1080×920 high resolution image object detection. Camera controller 244 may control camera 104 consistent with selected image processing algorithms, or vice versa. In various implementations, algorithm selection may jump over (skip) multiple algorithms (e.g., and associated camera control configurations), pause at the same algorithm, and so on, for example, based on the detected scenario.

In another example of adaptive resolution, a camera may support certain levels of resolution low to high, such as 2×3 pixels to 2000×3000 pixels (e.g., full resolution). 2×3 pixels can give an indication if a color (e.g., correlated color temperature (CCT)) changes in a camera field of view (FOV) over time. Upon detecting a change in color captured in image data, image processing may be changed to a higher resolution, such as 20×30 pixels. 20×30 pixels may provide a blurred image, but can detect one or more human gestures. User privacy may be maintained by not providing image data to the CPU or camera processor while maintaining low power processing with an ability to change to the next resolution (e.g., 100×150 pixel or 200×300) based on a determination that a user may be present. 100×150 or 200×300 pixels may provide more accurate indications of user gestures. 2000×3000 pixels (e.g., full resolution) may support biometric detection to authenticate a user.

In an example, presence sensing may start with a higher resolution, such as 200×300 pixels. After a period of time (e.g., a timeout) with no activity, the resolution may be reduced. This timeout procedure and reduction in camera resolution processing may be repeated (e.g., with the same or different timeouts) until the lowest resolution is reached. Based on pixel activity (e.g., detection of a change in color), adaptive resolution may “jump” straight to the 200×300 resolution, for example, for higher confidence detection. Resolution may decrease if it is determined that there is no human presence. An activity threshold for a timeout may be increased, for example, in response to determining there are one or more false transitions to the higher resolution.

In an example, an extremely low resolution is enough to differentiate color background and decide to switch image processing (e.g., and camera operation) to very low active mode, moving towards preparing the computing system for the user while the display and most components remain OFF. A transition to a very low resolution when a user is detected closer to the computing device improves tracking and preparation to switch the computing device ON (e.g., including the display). The computing device may switch on, ready for biometric detection, for example, once user close enough to interact with the computing device.

In an example of camera pixel mode management, multiple camera modes may be selected based on detected user presence scenarios. A single subpixel (e.g., green only) in the middle of the camera may be used while a room is detected as empty, causing a color change when the user arrives in front of the computing device. The computing device may transition to multiple subpixels (e.g., green and red only), for example, in the middle of the camera, in response to a detected color change. The computing device may transition to a single pixel (e.g., RGB), for example, in the middle of the camera, such that movement may be detected as a color change. The computing device may transition to multiple pixels (e.g., RGB), for example, in the middle of the camera to get heatmap, such that movement may be detected as a heatmap color change. Changes in resolution, e.g., low to high or vice versa may occur as needed, such as between single subpixel, single pixel, 4×8, 9×16, 36×64, 1080×920, and so on.

In an example of camera FOV management, multiple camera modes may be selected based on detected user presence scenarios. For example, in a user's absence, a computing device may only enable or may only process Frame subpixels/pixels (e.g., with middle pixel disabled). The camera may sense change on the edge of camera pixels, for example, as a user moves into camera view from the left or right edge of active camera. In a user's presence, the computing device may enable only central (e.g., middle) subpixels/pixels (e.g., while frame pixels are disabled). The camera may sense change in central pixels, for example, as a user sits in front of the camera, eliminating processing for a significant portion of camera pixels.

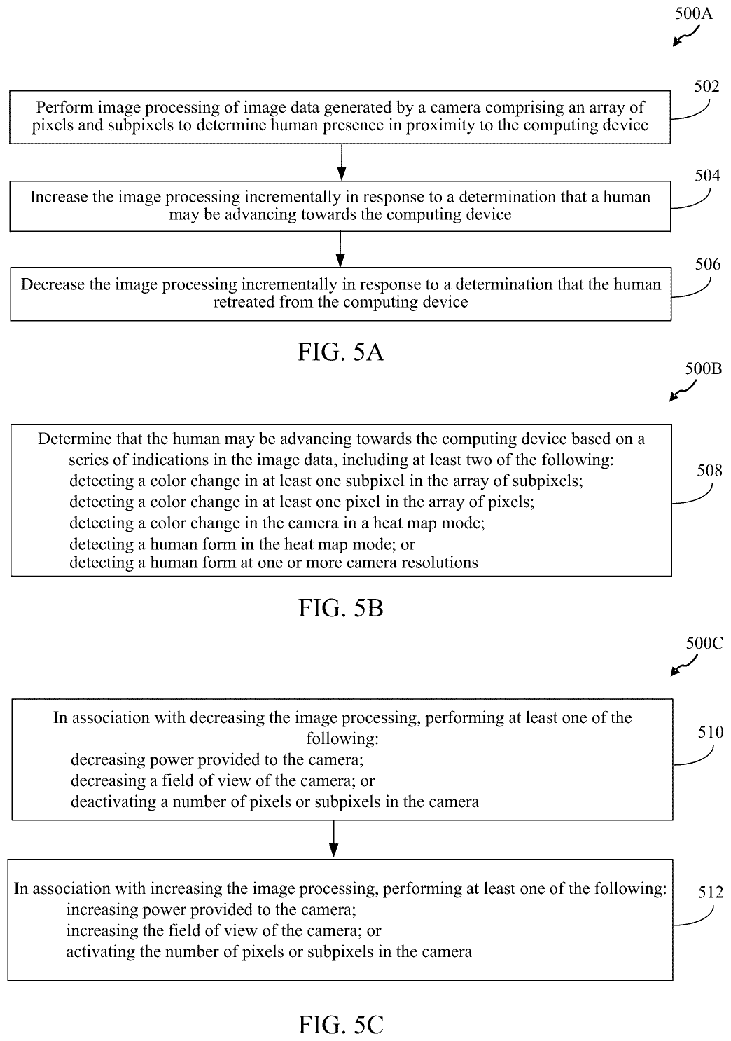

Embodiments described herein may operate in various ways. For instance, FIGS. 5A-5C show flowcharts 500A-500C of processes for user-sensing dynamic camera resolution control, according to an embodiment. Example computing system 100 or 200, as shown by examples in FIGS. 1 and 2, may operate according to flowcharts 500A-500C, e.g., in some embodiments. For example, example flowcharts 500A-500C may be implemented by image processor 114. Various embodiments may implement one or more steps shown in FIGS. 5A-5C with additional and/or alternative steps. Further structural and operational embodiments will be apparent to persons skilled in the relevant art(s) based on the following description of FIGS. 5A-5C.

Flowchart 500A includes step 502. In step 502, image processing of image data generated by a camera comprising an array of pixels and subpixels is performed to determine human presence in proximity to the computing device. For example, as shown in FIG. 1, image processor 114 may process image data 120 generated by camera 104 to determine user presence, as indicated by user presence indications 128.

In step 504, the image processing is increased incrementally in response to a determination that a human may be advancing towards the computing device. For example, as shown in FIG. 2, image processing controller 242 may select image processing algorithms 252 to increase image processing based on a series of determinations by low power image processor 246 that a user may be present and may be advancing towards computing device 102.

In step 506, the image processing is decreased incrementally in response to a determination that the human retreated (e.g., and remains absent) from the computing device. For example, as shown in FIG. 2, image processing controller 242 may select image processing algorithms 252 to decrease image processing based on a series of determinations by low power image processor 246 that a user may not be present after retreating from computing device 102.

Flowchart 500B includes step 508. In step 508, a determination is made that the human may be advancing towards the computing device based on a series of indications in the image data, including at least two of the following: detecting a color change in at least one subpixel in the array of subpixels; detecting a color change in at least one pixel in the array of pixels; detecting a color change in the camera in a heat map mode; detecting a human form in the heat map mode; or detecting a human form at one or more camera resolutions. For example, as shown in FIGS. 2 and 4, user presence determiner 240 may determine (e.g., and indicate to CPU 118 in user presence indications 128) that a user may be advancing towards computing device 102 after low power image processor 246 processes image data 120 using multiple image processing algorithms 252 selected by image processing controller 242 and determines that the increasing imaging processing algorithms identified changes in the environment in image data 120 indicating a user may be advancing towards computing device 102.

Flowchart 500C includes step 510. In step 510, in association with decreasing the image processing, at least one of the following are performed: decreasing power provided to the camera; decreasing a field of view of the camera; or deactivating a number of pixels or subpixels in the camera. For example, as shown in FIG. 2, camera controller 244 may select a camera configuration (e.g., power profile, FOV, active/inactive subpixels/pixels, etc.) indicated in camera control mode LUT 266 consistent with the image processing algorithm 252 selected by image processing controller 242.

In step 512, in association with increasing the image processing, at least one of the following are performed: increasing power provided to the camera; increasing the field of view of the camera; or activating the number of pixels or subpixels in the camera. For example, as shown in FIG. 2, camera controller 244 may select a camera configuration (e.g., power profile, FOV, active/inactive subpixels/pixels, etc.) indicated in camera control mode LUT 266 consistent with the image processing algorithm 252 selected by image processing controller 242.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code (program instructions) configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SOC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 6. FIG. 6 shows a block diagram of an exemplary computing environment 600 that includes a computing device 602. Computing device 602 is an example of computing device 102 shown in FIG. 1, which may include one or more of the components of computing device 602. In some embodiments, computing device 602 is communicatively coupled with devices (not shown in FIG. 6) external to computing environment 600 via network 604. Network 604 comprises one or more networks such as local area networks (LANs), wide area networks (WANs), enterprise networks, the Internet, etc., and may include one or more wired and/or wireless portions. Network 604 may additionally or alternatively include a cellular network for cellular communications. Computing device 602 is described in detail as follows.

Computing device 602 can be any of a variety of types of computing devices. For example, computing device 602 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 602 may alternatively be a stationary computing device such as a desktop computer, a personal computer (PC), a stationary server device, a minicomputer, a mainframe, a supercomputer, etc.

As shown in FIG. 6, computing device 602 includes a variety of hardware and software components, including a processor 610, a storage 620, one or more input devices 630, one or more output devices 650, one or more wireless modems 660, one or more wired interfaces 680, a power supply 682, a location information (LI) receiver 684, and an accelerometer 686. Storage 620 includes memory 656, which includes non-removable memory 622 and removable memory 624, and a storage device 690. Storage 620 also stores an operating system 612, application programs 614, and application data 616. Wireless modem(s) 660 include a Wi-Fi modem 662, a Bluetooth modem 664, and a cellular modem 666. Output device(s) 650 includes a speaker 652 and a display 654. Input device(s) 630 includes a touch screen 632, a microphone 634, a camera 636, a physical keyboard 638, and a trackball 640. Not all components of computing device 602 shown in FIG. 6 are present in all embodiments, additional components not shown may be present, and any combination of the components may be present in a particular embodiment. These components of computing device 602 are described as follows.

A single processor 610 (e.g., central processing unit (CPU), microcontroller, a microprocessor, signal processor, ASIC (application specific integrated circuit), and/or other physical hardware processor circuit) or multiple processors 610 may be present in computing device 602 for performing such tasks as program execution, signal coding, data processing, input/output processing, power control, and/or other functions. Processor 610 may be a single-core or multi-core processor, and each processor core may be single-threaded or multithreaded (to provide multiple threads of execution concurrently). Processor 610 is configured to execute program code stored in a computer readable medium, such as program code of operating system 612 and application programs 614 stored in storage 620. The program code is structured to cause processor 610 to perform operations, including the processes/methods disclosed herein. Operating system 612 controls the allocation and usage of the components of computing device 602 and provides support for one or more application programs 614 (also referred to as “applications” or “apps”). Application programs 614 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. Processor(s) 610 may include one or more general processors (e.g., CPUs) configured with or coupled to one or more hardware accelerators, such as one or more NPUs and/or one or more GPUs.

Any component in computing device 602 can communicate with any other component according to function, although not all connections are shown for ease of illustration. For instance, as shown in FIG. 6, bus 606 is a multiple signal line communication medium (e.g., conductive traces in silicon, metal traces along a motherboard, wires, etc.) that may be present to communicatively couple processor 610 to various other components of computing device 602, although in other embodiments, an alternative bus, further buses, and/or one or more individual signal lines may be present to communicatively couple components. Bus 606 represents one or more of any of several types of bus structures, including a memory bus or memory controller, a peripheral bus, an accelerated graphics port, and a processor or local bus using any of a variety of bus architectures.

Storage 620 is physical storage that includes one or both of memory 656 and storage device 690, which store operating system 612, application programs 614, and application data 616 according to any distribution. Non-removable memory 622 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 622 may include main memory and may be separate from or fabricated in a same integrated circuit as processor 610. As shown in FIG. 6, non-removable memory 622 stores firmware 618, which may be present to provide low-level control of hardware. Examples of firmware 618 include BIOS (Basic Input/Output System, such as on personal computers) and boot firmware (e.g., on smart phones). Removable memory 624 may be inserted into a receptacle of or otherwise coupled to computing device 602 and can be removed by a user from computing device 602. Removable memory 624 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 690 may be present that are internal and/or external to a housing of computing device 602 and may or may not be removable. Examples of storage device 690 include a hard disk drive, a SSD, a thumb drive (e.g., a USB (Universal Serial Bus) flash drive), or other physical storage device.

One or more programs may be stored in storage 620. Such programs include operating system 612, one or more application programs 614, and other program modules and program data. Examples of such application programs may include, for example, computer program logic (e.g., computer program code/instructions) for implementing image processor 114, user presence determiner 240, image processing controller 242, camera controller 244, low power image processor 246, low power audio processor 248, image processing algorithm(s) 252, and camera control mode LUT configurations 266, as well as for implementing flows 300 and 400, and/or flowcharts 500A, 500B, and/or 500C (as well as any individual steps included therein).

Storage 620 also stores data used and/or generated by operating system 612 and application programs 614 as application data 616. Examples of application data 616 include web pages, text, images, tables, sound files, video data, and other data, which may also be sent to and/or received from one or more network servers or other devices via one or more wired or wireless networks. Storage 620 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 602 through one or more input devices 630 and may receive information from computing device 602 through one or more output devices 650. Input device(s) 630 may include one or more of touch screen 632, microphone 634, camera 636, physical keyboard 638 and/or trackball 640 and output device(s) 650 may include one or more of speaker 652 and display 654. Each of input device(s) 630 and output device(s) 650 may be integral to computing device 602 (e.g., built into a housing of computing device 602) or external to computing device 602 (e.g., communicatively coupled wired or wirelessly to computing device 602 via wired interface(s) 680 and/or wireless modem(s) 660). Further input devices 630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 654 may display information, as well as operating as touch screen 632 by receiving user commands and/or other information (e.g., by touch, finger gestures, virtual keyboard, etc.) as a user interface. Any number of each type of input device(s) 630 and output device(s) 650 may be present, including multiple microphones 634, multiple cameras 636, multiple speakers 652, and/or multiple displays 654.

One or more wireless modems 660 can be coupled to antenna(s) (not shown) of computing device 602 and can support two-way communications between processor 610 and devices external to computing device 602 through network 604, as would be understood to persons skilled in the relevant art(s). Wireless modem 660 is shown generically and can include a cellular modem 666 for communicating with one or more cellular networks, such as a GSM network for data and voice communications within a single cellular network, between cellular networks, or between the mobile device and a public switched telephone network (PSTN). Wireless modem 660 may also or alternatively include other radio-based modem types, such as a Bluetooth modem 664 (also referred to as a “Bluetooth device”) and/or Wi-Fi modem 662 (also referred to as an “wireless adaptor”). Wi-Fi modem 662 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 664 is configured to communicate with another Bluetooth-capable device according to the Bluetooth short-range wireless technology standard(s) such as IEEE 802.15.1 and/or managed by the Bluetooth Special Interest Group (SIG).

Computing device 602 can further include power supply 682, LI receiver 684, accelerometer 686, and/or one or more wired interfaces 680. Example wired interfaces 680 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 680 of computing device 602 provide for wired connections between computing device 602 and network 604, or between computing device 602 and one or more devices/peripherals when such devices/peripherals are external to computing device 602 (e.g., a pointing device, display 654, speaker 652, camera 636, physical keyboard 638, etc.). Power supply 682 is configured to supply power to each of the components of computing device 602 and may receive power from a battery internal to computing device 602, and/or from a power cord plugged into a power port of computing device 602 (e.g., a USB port, an A/C power port). LI receiver 684 may be used for location determination of computing device 602 and may include a satellite navigation receiver such as a Global Positioning System (GPS) receiver or may include other type of location determiner configured to determine location of computing device 602 based on received information (e.g., using cell tower triangulation, etc.). Accelerometer 686 may be present to determine an orientation of computing device 602.

Note that the illustrated components of computing device 602 are not required or all-inclusive, and fewer or greater numbers of components may be present as would be recognized by one skilled in the art. For example, computing device 602 may also include one or more of a gyroscope, barometer, proximity sensor, ambient light sensor, digital compass, etc. Processor 610 and memory 656 may be co-located in a same semiconductor device package, such as being included together in an integrated circuit chip, FPGA, or system-on-chip (SOC), optionally along with further components of computing device 602.

In embodiments, computing device 602 is configured to implement any of the above-described features of flowcharts herein. Computer program logic for performing any of the operations, steps, and/or functions described herein may be stored in storage 620 and executed by processor 610.

In some embodiments, server infrastructure 670 may be present in computing environment 600 and may be communicatively coupled with computing device 602 via network 604. Server infrastructure 670, when present, may be a network-accessible server set (e.g., a cloud-based environment or platform). As shown in FIG. 6, server infrastructure 670 includes clusters 672. Each of clusters 672 may comprise a group of one or more compute nodes and/or a group of one or more storage nodes. For example, as shown in FIG. 6, cluster 672 includes nodes 674. Each of nodes 674 are accessible via network 604 (e.g., in a “cloud-based” embodiment) to build, deploy, and manage applications and services. Any of nodes 674 may be a storage node that comprises a plurality of physical storage disks, SSDs, and/or other physical storage devices that are accessible via network 604 and are configured to store data associated with the applications and services managed by nodes 674. For example, as shown in FIG. 6, nodes 674 may store application data 678.

Each of nodes 674 may, as a compute node, comprise one or more server computers, server systems, and/or computing devices. For instance, a node 674 may include one or more of the components of computing device 602 disclosed herein. Each of nodes 674 may be configured to execute one or more software applications (or “applications”) and/or services and/or manage hardware resources (e.g., processors, memory, etc.), which may be utilized by users (e.g., customers) of the network-accessible server set. For example, as shown in FIG. 6, nodes 674 may operate application programs 676. In an implementation, a node of nodes 674 may operate or comprise one or more virtual machines, with each virtual machine emulating a system architecture (e.g., an operating system), in an isolated manner, upon which applications such as application programs 676 may be executed.

In an embodiment, one or more of clusters 672 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 672 may be a datacenter in a distributed collection of datacenters. In embodiments, exemplary computing environment 600 comprises part of a cloud-based platform such as Amazon Web Services® of Amazon Web Services, Inc., or Google Cloud Platform™ of Google LLC, although these are only examples and are not intended to be limiting.

In an embodiment, computing device 602 may access application programs 676 for execution in any manner, such as by a client application and/or a browser at computing device 602. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 602 may additionally and/or alternatively synchronize copies of application programs 614 and/or application data 616 to be stored at network-based server infrastructure 670 as application programs 676 and/or application data 678. For instance, operating system 612 and/or application programs 614 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 620 at network-based server infrastructure 670.

In some embodiments, on-premises servers 692 may be present in computing environment 600 and may be communicatively coupled with computing device 602 via network 604. On-premises servers 692, when present, are hosted within an organization's infrastructure and, in many cases, physically onsite of a facility of that organization. On-premises servers 692 are controlled, administered, and maintained by IT (Information Technology) personnel of the organization or an IT partner to the organization. Application data 698 may be shared by on-premises servers 692 between computing devices of the organization, including computing device 602 (when part of an organization) through a local network of the organization, and/or through further networks accessible to the organization (including the Internet). Furthermore, on-premises servers 692 may serve applications such as application programs 696 to the computing devices of the organization, including computing device 602. Accordingly, on-premises servers 692 may include storage 694 (which includes one or more physical storage devices such as storage disks and/or SSDs) for storage of application programs 696 and application data 698 and may include one or more processors for execution of application programs 696. Still further, computing device 602 may be configured to synchronize copies of application programs 614 and/or application data 616 for backup storage at on-premises servers 692 as application programs 696 and/or application data 698.

Embodiments described herein may be implemented in one or more of computing device 602, network-based server infrastructure 670, and on-premises servers 692. For example, in some embodiments, computing device 602 may be used to implement systems, clients, or devices, or components/subcomponents thereof, disclosed elsewhere herein. In other embodiments, a combination of computing device 602, network-based server infrastructure 670, and/or on-premises servers 692 may be used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 620. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 614) may be stored in storage 620. Such computer programs may also be received via wired interface(s) 680 and/or wireless modem(s) 660 over network 604. Such computer programs, when executed or loaded by an application, enable computing device 602 to implement features of embodiments discussed herein. Accordingly, such computer programs represent controllers of the computing device 602.

Embodiments are also directed to computer program products comprising computer code or instructions stored on any computer-readable medium or computer-readable storage medium. Such computer program products include the physical storage of storage 620 as well as further physical storage types.

### IV. Additional Example Embodiments

Systems and methods are disclosed herein for user sensing dynamic camera resolution control. Dynamic adaptation of camera settings and/or image processing are based on sensed conditions, such as detected changes in an environment indicating actual or potential user presence approaching or retreating from a computing device. Dynamic adaptation of camera settings and/or image processing can conserve power and/or reduce user wait time by preparing to resume operation and greet a user as the user arrives at a computing device. An image processor uses sensed conditions to increment and decrement camera power consumption and/or image processing power consumption by dynamically switching between multiple stages, such as powering and/or processing a single subpixel, multiple subpixels, a single pixel, multiple pixels, multiple pixels in a heatmap mode, low, medium, and high/full resolution, at one or fields of view, based on a series of events detected using the camera sensor alone or combined with other sensors, such as a sound sensor (e.g., microphone).

In examples, a computing device comprises a camera comprising an array of pixels and subpixels configured to generate image data; and an image processor configured to reduce power consumption of the computing device by: performing image processing of the image data to determine human presence in proximity to the computing device; increasing the image processing incrementally (e.g., in stages) in response to a determination that a human may be advancing towards the computing device (e.g., in an inactive/low power state); and decreasing the image processing incrementally in response to a determination that the human retreated from the computing device (e.g., in an active state).

In examples, a determination that the human may be advancing towards the computing device comprises a series of indications in the image data, including at least two of the following: detecting a color change in at least one subpixel in the array of subpixels; detecting a color change in at least one pixel in the array of pixels; detecting a color change in the camera in a heat map mode; detecting a human form (e.g., or object) in the heat map mode; or detecting a human form at one or more camera resolutions.

In examples, the computing device further comprises a central processing unit. The image processor may comprise an image processor configured to indicate the determined human presence to the central processing unit for operating mode changes of the central processing unit.

In examples, the image processor may indicate to the central processing unit to activate at the end of a series of incremental increases in image processing and to turn off at the beginning of a series of incremental decreases in image processing.

In examples, the image processor is further configured perform at least one of the following: in association with decreasing the image processing, decreasing power provided to the camera; or in association with increasing the image processing, increasing power provided to the camera.

In examples, the image processor is further configured to reduce power consumption of the computing device by performing at least one of the following in association with decreasing the image processing: decreasing a field of view of the camera; or deactivating a number of pixels or subpixels in the camera.

In examples, the image processor is further configured to perform at least one of the following in association with increasing the image processing: increasing the field of view of the camera; or activating a number of pixels or subpixels in the camera.

In examples, decreasing the image processing incrementally comprises changing from performing image processing of image data generated by the array of pixels to performing image processing of image data generated by a first subset of pixels in the array of pixels in response to the image processing indicating that the human retreated from the computing device. In examples, increasing the image processing incrementally comprises changing from performing image processing of image data generated by the first subset of pixels in the array of pixels to performing image processing of image data generated by the array of pixels in response to the image processing indicating that the human is close enough to interact with the computing device.

In examples, decreasing the image processing incrementally comprises changing from performing image processing of image data generated by the first subset of pixels in the array of pixels to performing image processing of image data generated by a second, smaller, subset of pixels in the array of pixels in response to the image processing indicating that the human continued to retreat from the computing device. In examples, increasing the image processing incrementally comprises changing from performing image processing of image data generated by the second subset of pixels in the array of pixels to performing image processing of image data generated by the first subset of pixels in the array of pixels in response to the image processing indicating that the human continued to advance towards the computing device.

In examples, decreasing the image processing incrementally comprises changing the image processing from performing image processing of the image data generated by the second subset of pixels in the array of pixels to performing heatmap image processing of the second subset of pixels in response to the image processing indicating that there has been no human presence for a period of time. In examples, increasing the image processing incrementally comprises changing the image processing from performing the heatmap image processing of the image data generated by the second subset of pixels to performing image processing of the second subset of pixels in response to the image processing indicating that there has been no human presence for a period of time.

In examples, decreasing the image processing incrementally comprises changing the image processing from performing image processing of the image data generated by one pixel to performing image processing of the image data generated by one subpixel in response to the image processing indicating that there has been no human presence for a period of time. In examples, increasing the image processing incrementally comprises changing the image processing from performing image processing of the image data generated by one subpixel to performing image processing of the image data generated by one pixel in response to the image processing indicating that there may be initial human presence after a period of time without an indication of human presence.

In examples, a method comprises reducing power consumption of a computing device by: performing image processing of image data generated by a camera comprising an array of pixels and subpixels to determine human presence in proximity to the computing device; increasing the image processing incrementally in response to a determination that a human may be advancing towards the computing device; and decreasing the image processing incrementally in response to a determination that the human retreated from the computing device.

In examples, a determination that the human may be advancing towards the computing device comprises a series of indications in the image data, including at least two of the following: detecting a color change in at least one subpixel in the array of subpixels; detecting a color change in at least one pixel in the array of pixels; detecting a color change in the camera in a heat map mode; detecting a human form (e.g., or object) in the heat map mode; or detecting a human form at one or more camera resolutions.

In examples, the method may further comprise indicating the determined human presence to the central processing unit for operating mode changes of the central processing unit.

In examples, the image processor is further configured to reduce power consumption of the computing device by performing at least one of the following: in association with decreasing the image processing, decreasing power provided to the camera; or in association with increasing the image processing, increasing power provided to the camera.

In examples, the image processor is further configured to reduce power consumption of the computing device by performing at least one of the following: in association with decreasing the image processing, decreasing a field of view of the camera; or in association with increasing the image processing, increasing the field of view of the camera.

In examples, the image processor is further configured to reduce power consumption of the computing device by performing at least one of the following: in association with decreasing the image processing, deactivating a number of pixels or subpixels in the camera; or in association with increasing the image processing, activating the number of pixels or subpixels in the camera.

In examples, a computer-readable storage device may have instructions recorded thereon that, when executed, implement a method. The method may comprise reducing power consumption of a computing device by: performing image processing of image data generated by a camera comprising an array of pixels and subpixels to determine human presence in proximity to the computing device; increasing the image processing incrementally in response to a determination that a human may be advancing towards the computing device; and decreasing the image processing incrementally in response to a determination that the human retreated from the computing device.

In examples, a determination that the human may be advancing towards the computing device comprises a series of indications in the image data, including at least two of the following: detecting a color change in at least one subpixel in the array of subpixels; detecting a color change in at least one pixel in the array of pixels; detecting a color change in the camera in a heat map mode; detecting a human form (e.g., or object) in the heat map mode; or detecting a human form at one or more camera resolutions.

In examples, the method may further comprise indicating the determined human presence to the central processing unit for operating mode changes of the central processing unit.

In examples, the image processor is further configured to reduce power consumption of the computing device by performing at least one of the following: in association with decreasing the image processing, decreasing power provided to the camera; or in association with increasing the image processing, increasing power provided to the camera.

In examples, the image processor is further configured to reduce power consumption of the computing device by performing at least one of the following: in association with decreasing the image processing, decreasing a field of view of the camera; or in association with increasing the image processing, increasing the field of view of the camera.

In examples, the image processor is further configured to reduce power consumption of the computing device by performing at least one of the following: in association with decreasing the image processing, deactivating a number of pixels or subpixels in the camera; or in association with increasing the image processing, activating the number of pixels or subpixels in the camera.

In examples, the method may further comprise decreasing the image processing incrementally in response to a determination that the human is using the computing device but not the camera.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (e.g., or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (e.g., computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A computing device comprising:
a camera comprising an array of pixels and subpixels configured to generate image data; and
an image processor configured to reduce power consumption of the computing device by:
performing image processing of the image data to determine human presence in proximity to the computing device;
increasing the image processing incrementally in response to a determination that a human may be advancing towards the computing device; and
decreasing the image processing incrementally in response to a determination that the human retreated from the computing device.

2. The computing device of claim 1, wherein a determination that the human may be advancing towards the computing device comprises a series of indications in the image data, including at least two of the following:
detecting a color change in at least one subpixel in the array of subpixels;
detecting a color change in at least one pixel in the array of pixels;
detecting a color change in the camera in a heat map mode;
detecting a human form in the heat map mode; or
detecting a human form at one or more camera resolutions.

3. The computing device of claim 1, further comprising:
a central processing unit,
wherein the image processor comprises an image processor configured to indicate the determined human presence to the central processing unit for operating mode changes of the central processing unit.

4. The computing device of claim 1, wherein the image processor is further configured perform at least one of the following:
in association with decreasing the image processing, decreasing power provided to the camera; or
in association with increasing the image processing, increasing power provided to the camera.

5. The computing device of claim 1, wherein the image processor is further configured to reduce power consumption of the computing device by performing at least one of the following in association with decreasing the image processing:
decreasing a field of view of the camera; or
deactivating a number of pixels or subpixels in the camera.

6. The computing device of claim 1, wherein the image processor is further configured to perform at least one of the following in association with increasing the image processing:
increasing the field of view of the camera; or
activating a number of pixels or subpixels in the camera.

7. The computing device of claim 1,
wherein decreasing the image processing incrementally comprises changing from performing image processing of image data generated by the array of pixels to performing image processing of image data generated by a first subset of pixels in the array of pixels in response to the image processing indicating that the human retreated from the computing device; or
wherein increasing the image processing incrementally comprises changing from performing image processing of image data generated by the first subset of pixels in the array of pixels to performing image processing of image data generated by the array of pixels in response to the image processing indicating that the human is close enough to interact with the computing device.

8. The computing device of claim 7,
wherein decreasing the image processing incrementally comprises changing from performing image processing of image data generated by the first subset of pixels in the array of pixels to performing image processing of image data generated by a second, smaller, subset of pixels in the array of pixels in response to the image processing indicating that the human continued to retreat or remained absent from the computing device; or
wherein increasing the image processing incrementally comprises changing from performing image processing of image data generated by the second subset of pixels in the array of pixels to performing image processing of image data generated by the first subset of pixels in the array of pixels in response to the image processing indicating that the human continued to advance towards the computing device.

9. The computing device of claim 8,
wherein decreasing the image processing incrementally comprises changing the image processing from performing image processing of the image data generated by the second subset of pixels in the array of pixels to performing heatmap image processing of the second subset of pixels in response to the image processing indicating that there has been no human presence for a period of time, or
wherein increasing the image processing incrementally comprises changing the image processing from performing the heatmap image processing of the image data generated by the second subset of pixels to performing image processing of the second subset of pixels in response to the image processing indicating that there has been no human presence for a period of time.

10. The computing device of claim 9,
wherein decreasing the image processing incrementally comprises changing the image processing from performing image processing of the image data generated by one pixel to performing image processing of the image data generated by one subpixel in response to the image processing indicating that there has been no human presence for a period of time, or
wherein increasing the image processing incrementally comprises changing the image processing from performing image processing of the image data generated by one subpixel to performing image processing of the image data generated by one pixel in response to the image processing indicating that there may be initial human presence after a period of time without an indication of human presence.

11. A method, comprising:
reducing power consumption of a computing device by:
performing image processing of image data generated by a camera comprising an array of pixels and subpixels to determine human presence in proximity to the computing device;
increasing the image processing incrementally in response to a determination that a human may be advancing towards the computing device; and
decreasing the image processing incrementally in response to a determination that the human retreated from the computing device.

12. The method of claim 11, wherein a determination that the human may be advancing towards the computing device comprises a series of indications in the image data, including at least two of the following:
detecting a color change in at least one subpixel in the array of subpixels;
detecting a color change in at least one pixel in the array of pixels;
detecting a color change in the camera in a heat map mode;
detecting a human form in the heat map mode; or
detecting a human form at one or more camera resolutions.

13. The method of claim 11, further comprising:
indicating the determined human presence to a central processing unit for operating mode changes of the central processing unit.

14. The method of claim 11, further comprising:
performing at least one of the following:
in association with decreasing the image processing, decreasing power provided to the camera; or
in association with increasing the image processing, increasing power provided to the camera.

15. The method of claim 11, further comprising:
performing at least one of the following:
in association with decreasing the image processing, decreasing a field of view of the camera; or
in association with increasing the image processing, increasing the field of view of the camera.

16. The method of claim 11, further comprising:
performing at least one of the following:
in association with decreasing the image processing, deactivating a number of pixels or subpixels in the camera; or
in association with increasing the image processing, activating the number of pixels or subpixels in the camera.

17. A computer-readable storage device having instructions recorded thereon that, when executed, implement a method comprising:
reducing power consumption of a computing device by:
performing image processing of image data generated by a camera comprising an array of pixels and subpixels to determine human presence in proximity to the computing device;
increasing the image processing incrementally in response to a determination that a human may be advancing towards the computing device; and
decreasing the image processing incrementally in response to a determination that the human retreated from the computing device.

18. The computer-readable storage device of claim 17, wherein a determination that the human may be advancing towards the computing device comprises a series of indications in the image data, including at least two of the following:
detecting a color change in at least one subpixel in the array of subpixels;
detecting a color change in at least one pixel in the array of pixels;
detecting a color change in the camera in a heat map mode;
detecting a human form in the heat map mode; or
detecting a human form at one or more camera resolutions.

19. The computer-readable storage device of claim 17, further comprising:
performing at least one of the following:
in association with decreasing the image processing, decreasing a field of view of the camera; or
in association with increasing the image processing, increasing the field of view of the camera.

20. The computer-readable storage device of claim 17, further comprising:
performing at least one of the following:
in association with decreasing the image processing, deactivating a number of pixels or subpixels in the camera; or
in association with increasing the image processing, activating the number of pixels or subpixels in the camera.
